(19) United States
(12) Patent Application Publication
(10) Pub. No.: US 2018/0330275 A1
(43) Pub. Date: Nov. 15, 2018

(54) RESOURCE-EFFICIENT MACHINE LEARNING

(71) Applicant: Microsoft Technology Licensing, LLC, Redmond, WA (US)

(72) Inventors: Prateek Jain, Bangalore (IN); Chirag Gupta, Redmond, WA (US); Arun Sai Suggala, Redmond, WA (US); Ankit Goyal, Redmond, WA (US); Harshavardhan Simhadri, Redmond, WA (US)

(21) Appl. No.: 15/623,661

(22) Filed: Jun. 15, 2017

(30) Foreign Application Priority Data
May 9, 2017 (IN) 201741016375

(51) Int. Cl. G06N 99/00; G06N 5/04

(52) U.S. Cl. CPC G06N 99/005; G06N 5/04

(57) ABSTRACT

Generally discussed herein are devices, systems, and methods for machine-learning. A method may include training, based on sparseness constraints and using a first device, a sparse matrix, prototype vectors, prototype labels, and corresponding prototype score vectors, simultaneously, storing the sparse matrix, prototype vectors, and prototype labels on a random-access memory (RAM) of a second device, projecting, using the second device, a prediction vector of a second dimensional space to the first dimensional space, the first dimensional space less than the second dimensional space, determining whether the projected prediction vector is closer to the one or more first prototype vectors or the one or more second prototype vectors, and determining a prediction by identifying the which prediction outcome the projected prediction vector is closer to.

### RELATED APPLICATIONS

This application claims priority to India provisional patent application 201741016375 titled “RESOURCE-EFFICIENT MACHINE LEARNING” filed on May 9, 2017, the entire content of which is incorporated by reference herein in its entirety.

### BACKGROUND

A vast number of applications have been developed for consumer, enterprise and interconnected devices. Such applications include predictive maintenance, connected vehicles, intelligent healthcare, fitness wearables, smart cities, smart housing, smart metering, etc. The dominant paradigm for these applications, given the severe resource-constrained devices on which the applications run, has been just to sense the environment and to transmit the sensor readings to the cloud where the decision or prediction is made and possibly provided to the resource-constrained devices.

### SUMMARY

This summary section is provided to introduce aspects of embodiments in a simplified form, with further explanation of the embodiments following in the detailed description. This summary section is not intended to identify essential or required features of the claimed subject matter, and the combination and order of elements listed this summary section is not intended to provide limitation to the elements of the claimed subject matter.

A method of making a prediction may include constraining a number of non-zero entries of a sparse matrix to less than a specified first threshold, constraining a number of non-zero entries of prototype vectors to less than a specified second threshold, and constraining a number of non-zero entries of corresponding prototype score vectors to less than a specified third threshold, the sparse matrix and prototype vectors of a first dimensional space, the prototype vectors including first prototype vectors that represent a first prediction outcome and second prototype vectors that represent a second prediction outcome. The method may further include training, based on the constraints and using a first device, the sparse matrix, the prototype vectors, prototype labels, and the corresponding prototype score vectors simultaneously and storing the sparse matrix, prototype vectors, and prototype labels on a random-access memory (RAM) of a second device. The method may further include projecting, using the second device, a prediction vector of a second dimensional space to the first dimensional space, the first dimensional space less than the second dimensional space. The method may further include determining whether the projected prediction vector is closer to the one or more first prototype vectors or the one or more second prototype vectors. The method may further include determining a prediction by identifying (1) the first prediction outcome associated with the first prototype vectors in response to determining the projected prediction vector is closer to the one or more first prototype vectors and (2) the second prediction outcome associated with the second prototype vectors in response to determining the projected prediction vector is closer to the one or more second prototype vectors.

A non-transitory machine-readable medium including instructions for execution by a processor of a first device to perform operations including constraining a number of non-zero entries of a sparse matrix to less than a specified first threshold, constraining a number of non-zero entries of prototype vectors to less than a specified second threshold, and constraining a number of non-zero entries of corresponding prototype score vectors to less than a specified third threshold, the sparse matrix and prototype vectors of a first dimensional space, the prototype vectors including first prototype vectors that represent a first prediction outcome and second prototype vectors that represent a second prediction outcome, wherein a sum of the first, second, and third sizes is less than a storage capacity of the RAM. The operations may further include training, based on the constraints, the sparse matrix, the prototype vectors, prototype labels, and the corresponding prototype score vectors simultaneously. The operations may further include providing the sparse matrix, prototype vectors, and prototype labels on a random-access memory (RAM) of a second device, the RAM including a maximum of one megabyte storage.

A system may include a first device and a second device. The first device may include a first processor and a first memory device, the first memory device including a program stored thereon for execution by the first processor to perform first operations, the first operations comprising projecting, using a sparse matrix, first and second sets of known vectors of a first dimensional space to first and second sets of lower dimensional vectors, respectively, the first and second sets of lower dimensional vectors of a second dimensional space lower than the first dimensional space, the first and second sets of known vectors associated with a prediction. The operations of the first device may further include determining one or more first prototype vectors to represent the first lower dimensional vectors, the first prototype vectors of the second dimensional space. The operations of the first device may further include determining one or more second prototype vectors to represent the second lower dimensional vectors, the second prototype vectors of the second dimensional space. The operations of the first device may further include providing the first one or more prototype vectors, second one or more prototype vectors, and sparse matrix to a second device. The second device may further include a second processor and a random-access memory (RAM) device with a maximum of one megabyte of storage capacity coupled to the second processor, the RAM device including a program stored thereon for execution by the second processor to perform second operations, the second operations comprising projecting a prediction vector of a third dimensional space to the second dimensional space, the second dimensional space less than the third dimensional space. The operations of the second device may further include determining whether the projected prediction vector is closer to the one or more first prototype vectors or the one or more second prototype vectors. The operations of the second device may further include determining a prediction by identifying (1) the prediction associated with the first set of known vectors in response to determining the projected prediction vector is closer to the one or more first prototype vectors and (2) the prediction associated with the second set of known vectors in response to determining the projected prediction vector is closer to the one or more second prototype vectors.

### BRIEF DESCRIPTION OF THE DRAWINGS

FIG. 1 illustrates, by way of example, a block diagram of an embodiment of a prediction and training system.

FIG. 2 illustrates, by way of example, a general overview of a k-nearest neighbor prediction.

FIG. 3 illustrates, by way of example, a diagram of an embodiment of a method for prediction or decision making.

FIG. 4 illustrates, by way of example, a diagram of an embodiments of another method for prediction or decision making.

FIG. 5 illustrates, by way of example, a diagram of an embodiment of a machine, on which methods discussed herein may be carried out.

### DETAILED DESCRIPTION

In the following description, reference is made to the accompanying drawings that form a part hereof, and in which is shown by way of illustration, specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

The operations, functions, or algorithms described herein may be implemented in software in some embodiments. The software may include computer-executable instructions stored on computer or other machine-readable media or storage device, such as one or more non-transitory memories or other type of hardware based storage devices, either local or networked. Further, such functions may correspond to subsystems, which may be software, hardware, firmware or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using module(s) (e.g., processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, or the like)).

Embodiments discussed herein include performing a resource-efficient k-nearest neighbor prediction technique. One or more embodiments may improve upon prior k-nearest neighbor or other prediction techniques, such as by reducing a model size (e.g., an amount of memory, such as random access memory, which is consumed by the model size), an amount of time it takes to make the prediction, an amount of power consumed in making the prediction, and/or increasing an accuracy of the prediction.

Discussed herein are embodiments that may include making a prediction. The embodiments may include using lower power, less memory, and/or less time than other prediction techniques. Several approaches have attempted to perform predictions locally on devices with drawbacks. In one example, the device could be an Internet of Things (IoT) device. In some embodiments, the approach using the local prediction may be implemented for several scenarios including, but not limited to, predictions locally on the IoT devices, Machine Learning (ML) predictors that run in Level 1 (L1) cache of modern day computing devices, and predictors such as multi-class classification, multi-label classification, binary classification, or the like.

In multi-label classification multiple target labels are assigned to each training and prediction instance. In multi-label classification an input is mapped to a vector (as opposed to a scalar output as in multi-class classification). An example multi-label classification problem includes predicting whether one or more objects (e.g., characters, such as numbers or letters, entities, vehicles, structures, animals, plants, or the like) of a plurality of objects is present in an image.

In multi-class classification, an input is mapped to a scalar that is associated with a prediction. In such classification, it is assumed that each input is assigned to one and only one label. An example multi-class classification problem includes whether an object present in an image is one of three or more objects. Binary classification is a subset of multi-class classification with two possible classes.

Using kNN, a distance from an unknown input to all training vectors is measured. The k smallest distances are identified, and the most represented class by these k nearest neighbors is considered the output class label.

Other examples in which approaches discussed herein may be used include running low-latency ML techniques on a computing device (e.g., one or more mobile devices, laptops desktops, and servers, or the like), running ML techniques that can fit in the cache of a computing device, ML techniques analysing data (e.g., real time data) gathered from sensors, or the like. The prediction may be used by the device to perform an action.

Example applications that may be implemented using one or more embodiments include image classification (multi-label or multi-class image classification), sensor reading (multi-class, a plurality of sensors on body and measuring different parameters and the goal is to determine what activity is occurring (e.g., run, bike, climb, boat, walk, eat, talk, work, etc.), query-document pair (make prediction whether document, website, or the like is relevant to a query), factory (regression problem, sensors get information from machines and goal is to classify the number of products which were correctly produced). Many other applications exist, are contemplated by the inventors, and will be readily understood by one of ordinary skill in the art.

Certain real world applications require real-time prediction on resource-constraint devices, such as Internet of Things (IoT) devices, which are also referred to as IoT sensors. Such applications are growing rapidly, with sensor-based solutions for several IoT domains like housing, factories, even toothbrushes and spoons. Such rapid growth may be attributed to use of machine learning on data collected from the sensor. For example, smart factories measure temperature, noise, and various other parameters of each of the critical machines using sensors. This sensor data may then be used to preemptively schedule maintenance of a machine so that its failure does not halt a production chain.

However, machine learning in IoT scenarios is generally limited to cloud-based predictions, where large deep learning techniques operating in the cloud may be used to provide more accurate predictions. For example, the sensors/embedded devices, which have limited computing/storage abilities may be tasked with sensing and sending data to a cloud resource where the machine learning techniques provide predictions. However, in certain applications, real-time and accurate prediction on resource-constrained devices may be preferred for several machine learning domains due to privacy, bandwidth, latency, battery issues, or the like. For example, devices in factories might not want to send data to the cloud, because of communication, energy costs, and/or privacy.

Owing to constrained resources (e.g., processing, bandwidth (I/O), and/or memory resources of devices on which such application execute), such applications may require prediction models or techniques with limited memory utilization and/or computational complexity, while maintaining acceptable accuracy. For example, many ML models cannot be deployed on available resource constrained devices, which typically have a RAM of at most 32 kilobytes (KB) and processors with processing speed of 16 Megahertz. Recently, techniques to produce models, which are compressed compared to large deep neural network (DNN), kernel support vector machine (SVM), and/or gradient boosted decision trees (GBDT) have been proposed. However, none of these methods work effectively at the scale of IoT devices. Moreover, such techniques may not be naturally extended to solve issues other than the type of supervised learning problems they are designed for.

The present application discloses approaches for resource-efficient ML for performing predictions locally on resource-constrained devices. Such functionality may be implemented as logic circuitry or by way of executable machine-readable instructions deployed in the computing device. In one or more embodiments, the resource-efficient ML may implement a k-nearest neighbor (kNN) based prediction method.

The devices implementing a prediction technique discussed herein may be capable of processing general supervised learning issues and may produce desired accuracies with about 16 kB of model size on a variety of benchmark datasets. The techniques may include a kNN based model for performing the prediction owing to one or more of multiple reasons, such as generality of the kNN model, interoperability, ease of implementation on tiny devices, and small number of parameters to avoid overfitting. Further, kNN models may have a capability of determining complex decision boundaries. However, kNN technique in general may be associated with certain challenges, such as reduced accuracy, large model size, and large prediction time, which may limit its applicability in resource-constrained devices, such as IoT devices. Further, kNN based techniques are not considered to be a well-specified model as it is not clear, a priori, which distance metric to use to compare a given set of vectors. Further, kNN technique may require the entire training data in RAM for prediction, so its model size may be considered prohibitive in practice. Further, kNN technique may require computing the distance of a given test vector with respect to each training vector, which may not be possible in cases, where real-time prediction is to be performed.

To address the above-mentioned concerns of the kNN technique, certain systems and methods employ a class of methods implementing metric learning that may describe a task-specific metric for better accuracies. However, such techniques tend to increase model size and prediction time. For instance, a Large Margin Nearest Neighbor (LMNN) classifier, transforms an input space such that, in the transformed space, vectors from a same class are closer compared to vectors from disparate classes. However, such a method may increase the model size due to an additional transformation matrix. LMNN's transformation matrix may map data into lower dimensions, which may decrease model size but may still be prohibitive for most resource-scarce devices.

In other approaches, KD-trees may be used to decrease the prediction time but such methods increase the model size and lead to loss in accuracy. Certain methods implementing Stochastic Neighborhood. Compression (SNC) may be used decrease model size and prediction time by learning a small number of prototypes to represent the entire training dataset. In some examples, the prototypes may be chosen from original training data, while in certain other approaches artificial vectors for prototypes may be constructed. However, predictions of such methods are relatively inaccurate, especially in the reduced model size regime.

Moreover, the formulation of such an SNC based method may have a limited applicability to mostly binary and multi-class classification problems. SNC based method may also determine a set of prototypes such that the likelihood of a particular class probability model is maximized. Thus, SNC based method may apply only to multi-class issues and its extension to multilabel/ranking issues may be non-trivial.

The above-mentioned issues regarding kNN and other prediction techniques may be overcome by one or more embodiments described herein. Embodiments are further described herein regarding the accompanying figures. It should be noted that the description and figures relate to example implementations, and should not be construed as a limitation onto the present disclosure. It is also to be understood that various arrangements may be devised that, although not explicitly described or shown herein, embody the principles of the present disclosure. Moreover, all statements herein reciting principles, aspects, and embodiments of the systems and methods disclosed herein, as well as specific examples, are intended to encompass equivalents thereof.

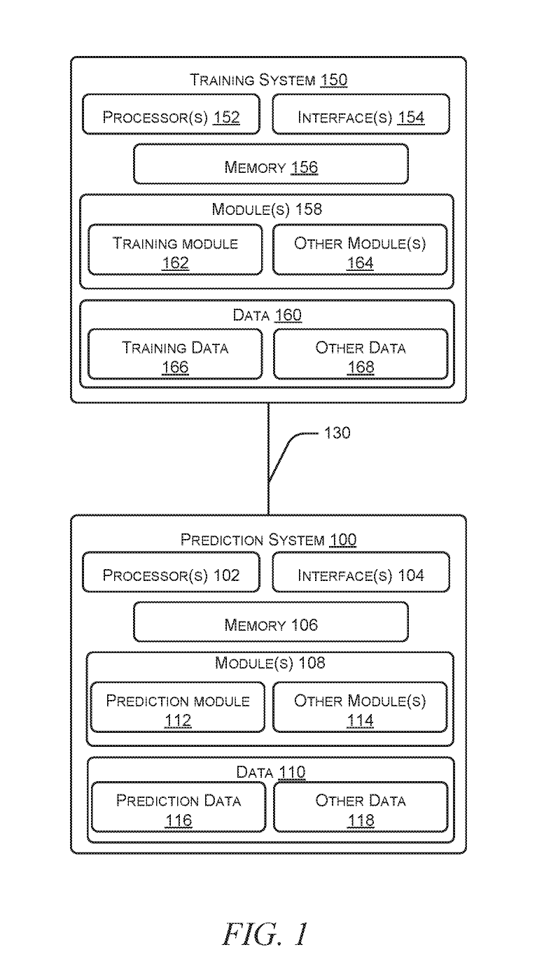

FIG. 1 illustrates, by way of example, a diagram of an embodiment of a prediction system 100 and a training system 150. In one or more embodiments, the prediction system 100 and the training system 150 may be implemented as discrete computing-devices. In one or more other embodiments, the prediction system 100 and the training system 150 may be implemented on the same computing device. The systems 100 and 150 may be configured for carrying out a computer-implemented method for performing predictions or training. The prediction may be performed locally, such as on a resource-constrained or another device. The systems 100 and 150 may include a laptop, desktop, cloud computing device, smartphone, IoT device, or the like, in one or more embodiments, the resource-constrained device (e.g., the prediction system 100) may include an Internet of Things (IoT) device and the training system 150 may include a laptop, desktop, or other compute device with more compute resource availability than the system 100. An IoT device has an Internet Protocol address and communicates with one or more other internet-connected devices. Many IoT devices are resource-constrained, such as to include limited amounts of RAM (e.g., less than one megabyte (MB), tens to hundreds of kilobytes (KB), 16 KB, 32 KB, 64 KB, 128 KB, 256 KB, 512 KB, or the like). In the future, additional resources, or resources with greater capacity, may be available on IoT devices, such as to include more than one MB of memory.

The IoT is an internetworking of IoT devices that include electronics, software, sensors, actuators, and network connectivity that allow the IoT devices to collect and/or exchange data. Note that embodiments discussed herein are applicable to more applications than just IoT devices. Any application/device that may benefit from quicker, lower power, fewer resource, or the like prediction capability, may benefit from one or more embodiments discussed herein.

The prediction system 100 may be implemented as a stand-alone computing device. Examples of such computing devices include laptops, desktops, tablets, hand-held computing devices such as smart-phones, smart sensor, or any other forms of computing devices. Continuing with the present implementation, the prediction system 100 may further include one or more processor(s) 102, interface(s) 104, and memory 106. The processor(s) 102 may also be implemented as signal processor(s), state machine(s), circuitry (e.g., processing or logic circuitry), and/or any other device or component that manipulate signals (e.g., perform operations on the signals, such as data) based on operational instructions.

The interface(s) 104 may include a variety of interfaces, for example, interfaces for data input and output devices, referred to as I/O devices, storage devices, network devices, and the like, for communicatively associating the prediction system 100 with one or more other peripheral devices. The peripheral devices may be input or output devices communicatively coupled with the prediction system 100, such as other IoT or other devices. The interface(s) 104 may also be used for facilitating communication between the prediction system 100 and various other computing devices connected in a network environment. The memory 106 may store one or more computer-readable instructions, which may be fetched and executed for carrying out a process for making a prediction or making a decision. The memory 106 may include any non-transitory computer-readable medium including, for example, volatile memory, such as RAM, or non-volatile memory such as EPROM, flash memory, and the like.

The prediction system 100 may further include module(s) 108 and data 110. The module(s) 108 may be implemented as a combination of hardware and programming (e.g., programmable instructions) to implement one or more operations of the module(s) 108. In one example, the module(s) 108 includes a prediction module 112 and other module(s) 114. The data 110 on the other hand includes prediction data 116, and other data 118.

In examples described herein, such combinations of hardware and programming may be implemented in several different ways. For example, the programming for the module(s) 108 may be processor (or other machine) executable instructions stored on a non-transitory machine-readable storage medium. The hardware for the module(s) 108 may include a processing resource (e.g., one or more processors or processing circuitry), to execute such instructions. In some of the present examples, the machine-readable storage medium may store instructions that, when executed by the processing resource, implement module(s) 108 or their associated functionalities. In such examples, the prediction system 100 may include the machine-readable storage medium storing the instructions and the processing resource to execute the instructions, or the machine-readable storage medium may be separate but accessible to prediction system 100 and the processing resource. In other examples, module(s) 108 may be implemented by electric or electronic circuitry.

In operation, the prediction module 112, is to implement one or more k-nearest neighbor prediction techniques. One objective is to minimize model size, prediction time, and/or prediction energy, while maintaining prediction accuracy, even at the expense of increased training costs (e.g., compute cycles, power consumption, time, or the like). The prediction module 112 may be trained on a laptop and then burnt, along with the prediction code, onto the memory 106 (e.g., the flash memory, or random access memory (RAM)) of the system 100. After deployment, the memory 106 may be read-only, and all features, variables and intermediate computations may be stored in the memory 106.

The systems and methods of the present disclosure may be adapted to many other settings and architectures. In the following description, various functions, processes and steps, in one implementation, may be performed by the prediction module 112 or a separate device, such as in the case of training prototypes, distance metric, and/or corresponding parameters. It should be noted that any other module, when suitably programmed, may also perform such functions without deviating from the scope of the present disclosure. The advantages of the present disclosure are provided regarding embodiments as described below. It should also be understood that such implementations are not limiting. Other implementations based on similar approaches would also be within the scope of the present disclosure.

The training system 150 includes components like the prediction system 100, such as the processors 152, interfaces 154, memory 156, other module(s) 164, and other data 168. The modules 158 may be like the modules 108 with the modules 158 including the training module 162. The data 160 may be like the data 110, with the data 160 including the training data 166.

The training system 150 determines prototype vectors, bₘ, and corresponding parameters, such as a sparse projection matrix, W, a label vector for each prototype, bₘ, and/or a score vector, zₘ, for each prototype. The training of the prototypes and parameters may be accomplished jointly, such as by training all of them together. The training module 162 may use the training data 166 to determine the prototypes and the parameters. The training data 166 may include input-output examples, which indicate a desired output for a given input. Such training may include using stochastic gradient descent or projected gradient descent. Such a training allocates a specific amount of memory to operations performed making the prediction, thus allowing the model to be constrained to a specific memory space.

The training system 150 provides the prototypes and other model parameters to the prediction system 100, such as on connection 130. The connection 130 may include a wired or wireless connection. The wired or wireless connection may provide a direct connection (a connection with no other device coupled between the training system 150 and the prediction system 100) or an indirect connection (a connection with one or more devices coupled between the training system 150 and the prediction system 100).

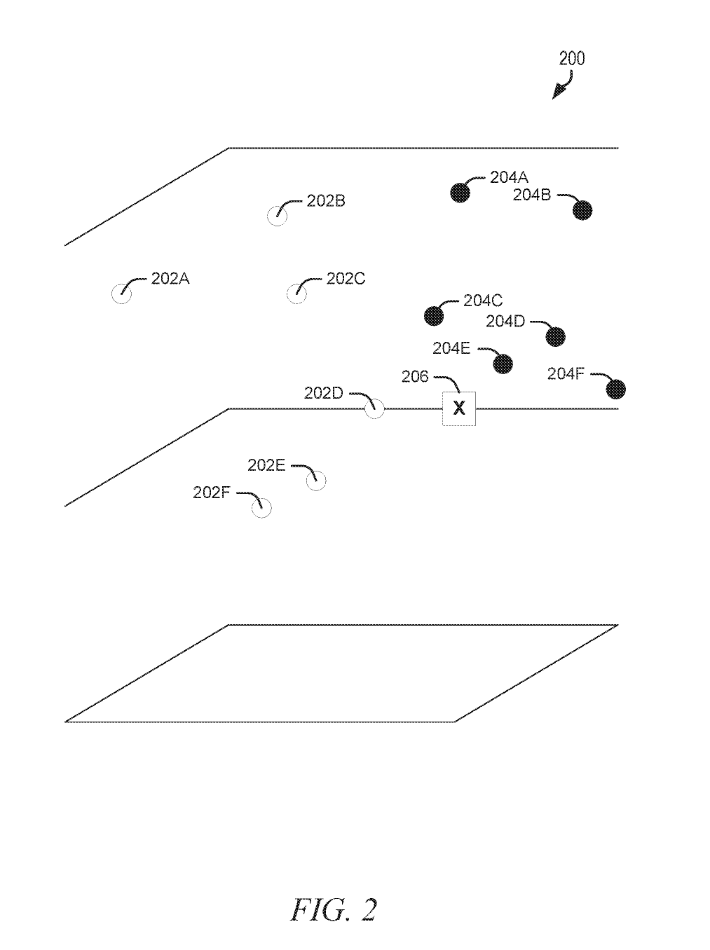

FIG. 2 illustrates, by way of example, a diagram of a kNN decision space 200. The decision space 200 includes a number of dimensions, U, where T is an integer. The decision space 200 as illustrated includes first test vectors 202A, 202B, 2020, 202D, 202E, and 202F, second test vectors 204A, 204B, 2040, 204D, 204E, and 204F, and a prediction vector 206. A goal of a kNN prediction technique is to determine whether the prediction vector 206 is a member of the first test vectors 202A-202F or the second test vectors 204A-204F, ultimately deciding what the prediction vector 206 represents.

In performing the determination of which test vectors the prediction vector 206 belongs, a distance heuristic may be used. The distance heuristic can include a variety of different distance heuristics, such as can include a learned gradient. Determining which distance heuristic is sufficiently accurate for given sets of test vectors is quite challenging. Other disadvantages of the kNN technique may include a large model size. The model size of the kNN technique typically includes all the test vectors 202A-202F and 2044-204F and other model parameters. These test vectors 202A-202F 204A-204F consume a large amount of space in a memory of the device performing the prediction or making the decision. Further yet, typical kNN techniques perform a distance measurement between the prediction vector 206 and all test vectors 202A-202F and 204A-204F. Some aggregate of the distances between one or more of the respective test vectors 202A-202F, 204A-204F and the prediction vector 206 and the prediction vector 206. Whichever set of test vectors 202A-202F and 204A-204F includes more vectors closest to the prediction vector is considered the test set to which the prediction vector 206 belongs. Such a calculation and comparison may consume too large an amount of time and/or compute resources to be implemented on resource-constrained devices.

System and methods that may implement a kNN based prediction technique for resource-efficient ML in resource-constrained devices or non-constrained devices are described herein. Such systems and methods address one or more of the above-mentioned issues, such as in an IoT domain, and such as without compromising on accuracy. In an example, the kNN based prediction technique implements sparse projections, a small number of test vector prototypes, and/or joint optimization of projections, prototypes, scores, or other parameters. As the projections may be in a lower-dimensional space (lower-dimensional relative to the data that was projected into the lower-dimensional space), and the prototypes may be in limited number, this may provide for significantly reducing model size, and/or prediction time without significant loss in accuracy. Moreover, joint optimization of the projections and prototypes further enhances the accuracy. These aspects are discussed in detail the following paragraphs.

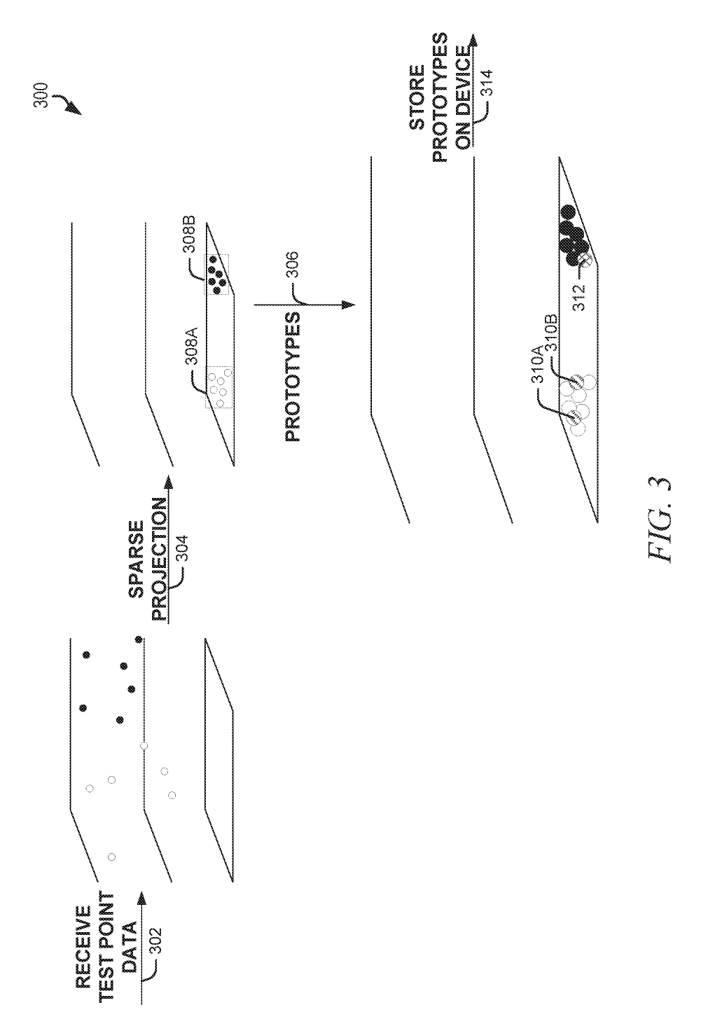

FIG. 3 illustrates, by way of example, a diagram of an embodiment of a kNN training technique 300 that may overcome one or more disadvantages of previous kNN techniques. The kNN technique 300 can be performed by the training system 150, such as the training module 162, the memory 156, processor(s) 152, training data 166, and/or interface(s) 154 of the training system 150. The training technique 300 includes receiving test vector data, at operation 302. The test vector data can include the test vector 202A-202F and 204A-204F from FIG. 2. The test vector data can be received through interface(s) 154, stored in the memory 156, or as part of the training data 166.

The technique 300 further includes performing a sparse projection on the test vector data received at operation 302, at operation 304. The sparse projection may operate to reduce a dimensionality of the test vector data, increase a distance between vectors of lower-dimensional test vector sets, and/or to help discern what distance metric may be used to determine to which set of vectors a prediction vector belongs. The dimensionality of the test vectors after the sparse projection may be an integer, T, that is strictly less than the dimensionality of the test vectors, U.

Consider a test vector that is an image with a 32×32 grid of pixels. Projecting the image to a lower-dimensional space can include performing one or more operations on the image to produce a representation of the image that includes a grid of values less than the 32×32 grid. In one or more embodiments, the grid of values can be sparse, such as to include hundreds of non-zero entries, tens of non-zero entries, or less. Similar projections can be made for documents, vectors of sensor inputs, or other input test vectors.

The technique 300 further includes determining one or more prototype test vectors 310A, 310B, and 312 for each of the lower-dimensional test vector sets 308A and 3088. The prototype test vectors 310A-31.0B represent prototype test vectors for the test vector set 308A. The prototype test vector 312 represents a prototype test vector for the test vector set 308B. The prototype test vectors 310A-310B and 312 may be from the test vector sets 308A-308B (e.g., by random selection or other selection method) or vectors outside of the test vector sets 308A-308B (e.g., by determining a cluster center or other location within a cluster comprised of the respective test vector sets 308A-308B). The prototype test vectors 310A-310B and 312 may be produced to reduce a model size, such as by reducing a number of test data vectors that represent a decision or prediction. The prototype test vectors 310A-310B and 312 may be produced to reduce a time it takes a device to make a prediction or decision.

The prototypes 306, bₘ, and the sparse projection matrix, W, may be stored on a device that is to make a prediction or decision, at operation 314. The prototypes and the sparse projection matrix may be stored on a random-access memory of the device, such as the memory 106 or as part of the training data 116.

While the FIGS. 2 and 3 generally illustrate a binary decision or prediction, it is to be understood that the embodiments discussed herein are applicable to decisions or predictions that involve more than two possible results.

What follows is more details regarding the operations of the technique 300 as well as operations in using parameters for determining a prediction or making a decision. For example, the technique of the present disclosure may be generalized for multi-label or ranking problems.

For sparse (e.g., a number of zero-valued entries in a sparse matrix is greater than a number of non-zero valued entries in the sparse matrix), low-dimensional projection (lower dimensional than the dimension of the test vector data), such as the operation 304, the test data and prediction vector may be projected to the lower-dimensional space (e.g., using a sparse projection matrix). The systems and/or techniques may determine prototype data vectors that may be used to represent the entire training dataset. Labels for each prototype data vector may also be determined. A label identities possible classifications and corresponding percentage values that indicate how likely it is that the vector represents the classification. The labels may help improve accuracy and/or provide additional flexibility. The sparse projection matrix, prototype data sets, and/or labels for the prototype data sets may be jointly learned, such as to provide improved accuracy in the projected space over training the sparse projection matrix, prototype data sets, and/or labels separately.

The projection matrix, the prototypes, score vectors, and/or the labels may jointly discriminate, such as to optimize a given loss function. The explicit sparsity constraints (e.g., required so that the model size and/or prediction time requirements are met) may be imposed on parameters e.g., the projection matrix, prototypes, scores, and/or labels) so that a model within the given model-size may be obtained in training. Such techniques and systems may outperform previous solutions that include post-facto pruning to fit the model in memory or meet a specified time to prediction or decision.

The optimization problem for determining the prediction or decision model, such as for a resource-constrained device, may be non-convex with hard L₀ constraints, however, a stochastic gradient descent (SGD) technique with hard-thresholding for optimization may still be used to determine the model. Nevertheless, the kNN based prediction method may still be implemented efficiently, and may handle datasets with millions of test vectors with state-of-the-art accuracies.

A kNN based prediction method is explained in detail in subsequent paragraphs. Given n data vectors, X=[x₁, x₂, . . . xₙ]^{T} and the corresponding target output Y=[y₁, y₂, . . . yₙ]^{T}, where xᵢ ∈R^{d}, yi ∈Y, the kNN prediction mechanism is to predict a desired output of a given test vector. Further, as mentioned above, the kNN based method is to have a small size. For both the multi-label/multi-class problems with L labels, yi∈{0, 1}^{L}, but in multi class ∥yᵢ∥=1. Similarly, for ranking problems, the output yᵢ is a permutation.

Consider a smooth version of a kNN prediction function for the above given general supervised learning problem:

ŷ=σ⁻¹(ŝ)=σ⁻¹(Σᵢ₌₁ⁿσ(yᵢ)K(x,xᵢ)) Eqn. 1

where ŷ is the predicted output for a given input x, ŝ=σ⁻¹(Σᵢ₌₁ⁿσ(yᵢ)K(x,xᵢ)) is a score vector for x. σ:γ→ [symbol] ^{L} maps a given output into a score vector and σ⁻¹: [symbol] →γ maps the score function back to the output space. For example, in the multi-class classification, σ is the identity function while σ⁻¹=Topᵢ, where [Topᵢ (s)]ⱼ=1 if sⱼ is the largest element and 0 otherwise. Continuing, K: [symbol] ^{d}× [symbol] ^{d}→ [symbol] is a similarity function (e.g., K (xᵢ, xⱼ) computes a similarity between xᵢ and xⱼ). For example, standard kNN uses K(x, xᵢ)=([xᵢ∈Nk (x)] where Nk (x) is the set of k nearest neighbors of x in X.

As per the present disclosure, when performing kNN prediction or decision, an entire X may be stored in memory. In such predictions (or decisions) the model size and/or prediction time (at least for naive implementation) may be O(nd), which, in general, is prohibitive for resource constrained devices. So, to reduce model size and prediction complexity of kNN, prototypes that represent the entire training data may be used. That is, prototypes B=[b₁, . . . , bₘ] and the corresponding score vectors Z=[z₁, . . . , zₘ]∈1 [symbol] ^{LX m} may be determined, so that the decision function is given by:

$$\hat{y} = {σ}^{- 1} ( {\sum }_{j = 1}^{m} {z}_{j} K ( x , {b}_{j} ) )$$

Certain previously existing prototype based approaches, like SNC, include a specific probabilistic model for multi-class problems with the prototypes as the model parameters. In contrast, present embodiments describe a direct discriminative learning approach that allows for better accuracies in several settings, along with generalization to any supervised learning problem (e.g., multi-label classification, regression, ranking, etc.).

However, K is a fixed similarity function like radial basis function (RBF) kernel, which is not tuned for the present approach and may lead to inaccurate results. Instead, a low dimensional matrix W ∈ [symbol] ^{\hat{d}×d} may be determined. The low dimensional matrix may further reduce model or prediction complexity, and may transform data into a space, such as a space in which prediction is more accurate.

In one example, a prediction function may be based on the three sets of learned parameters W∈ [symbol] ^{\hat{d}×d}, B=[b₁, . . . , bₘ]∈ [symbol] ^{\hat{d}×m}, and Z=[z₁, . . . , zₘ]∈ [symbol] ^{L×m};

ŷ=σ⁻¹(Σⱼ₌₁^{m}zⱼK(Wx,bⱼ)) Eqn. 2

To further reduce the model/prediction complexity, a sparse set of Z, B, W may be determined. Further, the similarity function K may be appropriately determined as it is central to performance of the systems and methods of the present disclosure. K may be a Gaussian kernel: K_{γ} (x, y)=exp{−γ²ix−y²}.

Now, if m=n, and W=I_{d×d}, then the prediction function reduces to a standard RBF kernel-support vector machine (SVM) decision function for binary classification. Thus, the prediction function is universal, (e.g., it can learn any arbitrary function given enough data and model complexity). As per present disclosure, with reasonably small amount of model complexity, the kNN based prediction technique nearly matches RBF-SVTs prediction error.

Further, the formal optimization problem may be addressed to determine parameters Z, B, and W. Let L)ŝ, y) be the loss (or) risk of predicting score vectors ŝ for a vector with label vector y. For example, the loss function can be standard hinge-loss for binary classification, or Normalized Discounted Cumulative Gain (NDCG) loss function for ranking problems, etc.

An empirical risk associated with Z, B, and W in such a circumstance may be defined as:

$${R}_{emp} ( Z , B , W ) = 1 / n {\sum }_{i = 1}^{n} L ( {y}_{i} , {\sum }_{j = 1}^{m} {z}_{j} {K}_{ϒ} ( {b}_{j} , {W}_{{x}_{i}} ) )$$

To jointly learn Z, B, and W, the empirical risk may minimized with explicit sparsity (e.g., memory) constraints:

$${min}_{Z : {‖ Z ‖}_{0} \leq {s}_{Z} , B : {‖ B ‖}_{0} \leq {s}_{B} , W : {‖ W ‖}_{0} \leq {s}_{W}} {R}_{emp} ( Z , B , W ) \qquad Eqn . 3$$

where ∥Z∥₀ is equal to the number of non-zero entries in Z. For multi-class/multi-label experiments that are discussed in India provisional patent application 201741016375, the L2 loss function was used. Such a loss function helps determine the gradients (distance metric) and allows the present method to converge faster than other techniques, and in a robust manner. That is,

$${R}_{emp} ( Z , B , W ) = \frac{1}{n} {\sum }_{i = 1}^{n} {‖ {y}_{i} - {\sum }_{j = 1}^{m} {z}_{j} {K}_{ϒ} ( {b}_{j} , {W}_{{x}_{i}} ) ‖}_{2}^{2} .$$

The sparsity constraints described above provide control over the model size. Jointly training all three parameters together leads to highest accuracy, as is explained elsewhere herein or in the India provisional patent application 201741016375. In case of jointly training, W may be more important (for accuracy of the prediction) than Z and/or B, for binary classification. Z may be more important (for accuracy of the prediction) for multi-label classification.

An example method of optimizing equation (3), which is non-convex, is described. In the example method, an alternating reduction technique for optimization may be used. Here, one of Z, B, or W may be minimized while fixing the other two parameters. The resulting optimization problem in each of the alternating steps may still be non-convex. To optimize these sub-problems, Stochastic Gradient Descent (SGD) for large data sets and projected Gradient Descent (GD) for small datasets may be used.

Considering that the objective is to be minimized w.r.t Z by fixing B. W, then in each iteration of SGD, randomly a mini-batch S⊆[1, . . . n] may be sampled and Z may be updated as:

$$Z ← {HT}_{sZ} ( Z - η {\sum }_{i ∈ S} {∇}_{Z} {L}_{i} ( Z , B , W ) )$$

where HT_{sz} (A) is a hard thresholding operator that thresholds the smallest L×m−s_{Z} entries magnitude) of A. Lᵢ (Z, B, W) is the risk at i^{th} data vector, (i.e. Lᵢ(Z, B, W)=L (yᵢ, Σⱼ₌₁^{m}zᵢK_{Y}(bⱼ, Wₓ_{ᵢ}))) and ∇_{Z}Lᵢ (Z, B, W) denotes its partial derivative with respect to (w.r.t) Z. The GD procedure is SGD with batch |S|=n. An example pseudo code for optimization of equation (3) is provided:

Input: data(X, Y), sparsity (s_{Z}, s_{B}, s_{W}), kernel parameter γ, projection
dimension \hat{d}, number of prototypes m, iterations T, and training epochs e.
Initialize Z, B, W

| For t=1 to T | | */begin alternating minimization/* |
|---|---|---|
| | repeat | */begin optimization of Z/* |

randomly sample S ⊆ [1, . . . n]
Z ← HT_{sZ}(Z − ηᵣ Σ_{i∈S} ∇_{Z}Lᵢ(Z, B, W))

| | |
|---|---|
| until e epochs | */end optimization of Z/* |
| repeat | *^{/}begin optimization of B/* |

randomly sample S ⊆ [1, . . . n]
B ← HT_{sB}(B − ηᵣ Σ_{i∈S} ∇_{B}Lᵢ(Z, B, W))

| | |
|---|---|
| until e epochs | */end optimization of B/* |
| repeat | *^{/}begin optimization of W/* |

randomly sample S ⊆ [1, . . . n]
W ← HT_{sW} (W − ηᵣ Σ_{i∈S} ∇_{W}Lᵢ(Z, B, W))

| | |
|---|---|
| until e epochs | */end optimization of W/* |

| | |
|---|---|
| end for | */end alternating minimization/* |

Output: Z, B, W

Note that the parameters in the above pseudocode are optimized in the order of Z, then B, then W, but other orders may be used, such as Z, then W, then B; B, then Z, then W, or the like.

To ensure convergence of SGD methods, especially for non-convex optimization problems, step-size is to be determined correctly. In an example of the present technique, the initial step size may be selected using the Armijo rule, and Subsequent step sizes are selected as ηₜ=η₀/t where η₀ is the initial step-size.

Further, since the objective function (3) is non-convex, good initialization for Z, B, and W may help in converging to a local optimum. To accomplish this, a Gaussian matrix may be randomly sampled to initialize W for binary and small multi-class benchmarks. However, for large multi-class datasets (e.g., aloi), large margin nearest neighbor (LMNN) based initialization of W may be used. Similarly, for multi-label datasets, sparse local embeddings for extreme multi-label classification (STEEC), which is an embedding technique for large multi-label problems, may be used.

In an example, for initialization of prototypes, B, at least two different approaches may be used. In a first technique, which may be used for multilabel problems, training data vectors may be randomly sampled in the transformed space and these may be assigned as the prototypes. In another approach, k-means clustering in the transformed space may be performed on data vectors belonging to each class and the cluster centers may be used as the prototypes. The second approach, may be used for binary and/or multi-class problems.

Although, the example pseudo code described above optimizes an lₒ constrained optimization problem, the kNN based technique of present disclosure still converges to a local minimum due, at least in part, to a smoothness of an objective function. Moreover, if the objective function satisfies strong convexity in a small area around an optima, then appropriate initialization may lead to convergence to that optima. The same may be observed from experimental results provided in the India provisional patent application 201741016375, where the empirical results indicate that the objective function converges at a fast rate to a good local optimum leading to accurate models.

The performance of the present disclosure is compared with respect to various benchmark binary, multi-class, and multi-label datasets in India provisional patent application number 201741016375, titled “RESOURCE-EFFICIENT MACHINE LEARNING” and filed on May 9, 2017, which is incorporated herein by reference in its entirety.

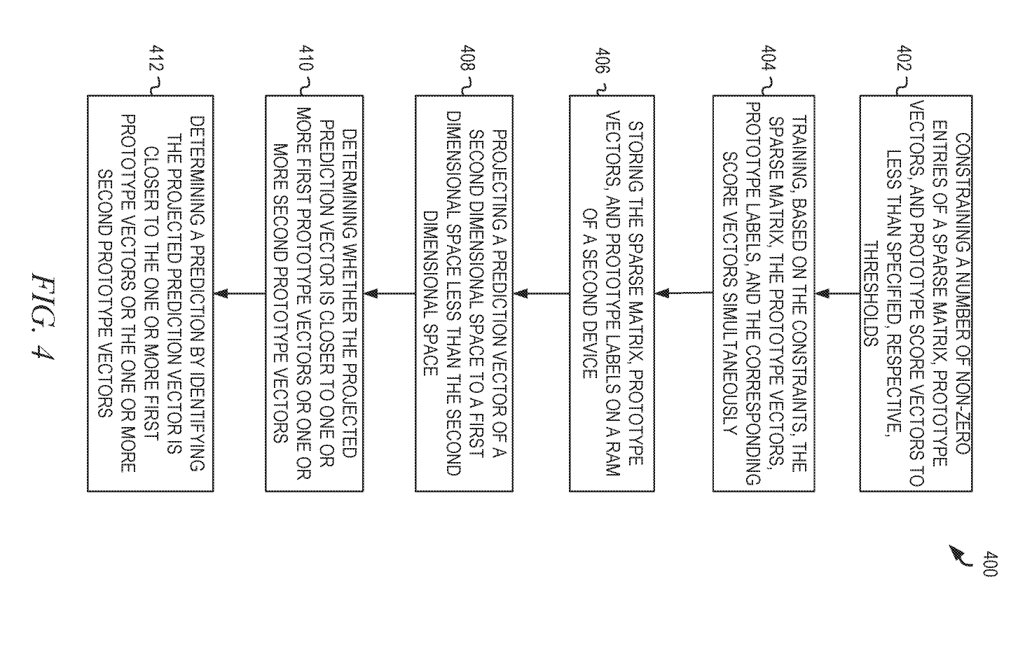

FIG. 4 illustrates, by way of example, an embodiment of a method 400 for making a prediction, using a computing device, a prediction and/or decision. The method 400 may be performed by one or more components of the training system 150 and/or prediction system 100. The prediction or decision may be provided to an external device, such as by circuitry of the device, to be used in analytics, or otherwise cause a device or person to perform an operation. The method 400 as illustrated includes constraining a number of non-zero entries of a sparse matrix, prototype vectors, and prototype score vectors to less than a specified threshold, at operation 402; training, based on the constraints, the sparse matrix, the prototype vectors, prototype labels, and the corresponding score vectors simultaneously, at operation 404; storing the sparse matrix, prototype vectors, and prototype labels on a RAM of a second device, at operation 406; projecting a prediction vector of a second dimensional space to a first dimensional space less than the second dimensional space, at operation 408; determining whether the projected prediction vector is closer to one or more first prototype vectors (of the prototype vectors) or one or more second prototype vectors (of the prototype vectors), at operation 410; and determining a prediction by identifying the projected prediction vector is closer to the one or more first prototype vectors or the one or more second prototype vectors, at operation 412.

The operation 402 may include constraining a number of non-zero entries of a sparse matrix to less than a specified first threshold, constraining a number of non-zero entries of prototype vectors to less than a specified second threshold, and constraining a number of non-zero entries of corresponding prototype score vectors to less than a specified third threshold. The sparse matrix and prototype vectors may be of a first dimensional space. The prototype vectors may include first prototype vectors that represent a first prediction outcome and second prototype vectors that represent a second prediction outcome. The operations 402 and 404 may be performed by the training system 150.

The operations 406, 408, 410, and 412 may be performed by the prediction system 100. The operation 412 may include determining a prediction by identifying (1) the first prediction outcome associated with the first prototype vectors in response to determining the projected prediction vector is closer to the one or more first prototype vectors and (2) the second prediction outcome associated with the second prototype vectors in response to determining the projected prediction vector is closer to the one or more second prototype vectors.

The method 400 may further include projecting, (e.g., using the training system 150) using the sparse matrix, first and second sets of known vectors of a third dimensional space to first and second sets of lower dimensional vectors, the first and second sets of known vectors associated with the first and second predictions, respectively, determining the one or more first prototype vectors to represent the first lower dimensional vectors, and determining the one or more second prototype vectors to represent the second lower dimensional vectors. Determining the one or more first prototype vectors may include randomly selecting one or more first lower dimensional vectors of the first set of lower dimensional vectors, and determining the one or more second prototype vectors includes randomly selecting one or more second lower dimensional vectors of the second set of lower dimensional vectors. Determining the one or more first prototype vectors includes selecting a cluster center of the first lower dimensional vectors, determining the one or more second prototype vectors includes selecting a cluster center of the second lower dimensional vectors, and wherein the prediction is a binary or multi-class prediction.

The operation 404 may further include, wherein training the sparse matrix, the prototypes, the prototype labels, and the score vectors simultaneously, includes performing a stochastic gradient descent or projected gradient descent depending on a size of the first and second sets of known vectors. The operation 404 may further include, wherein training the sparse matrix further includes using an alternating reduction technique that includes fixing the prototypes and prototype values to respective fixed values while adjusting the sparse matrix based on the fixed values. The operation 404 may further include, wherein training the sparse matrix further includes reducing an L2 loss function. The method 400 may further include, wherein a sum of the first, second, and third thresholds is less than a storage capacity of the RAM and the prototypes, prototype labels, score vectors, and sparse matrix are all stored on the RAM.

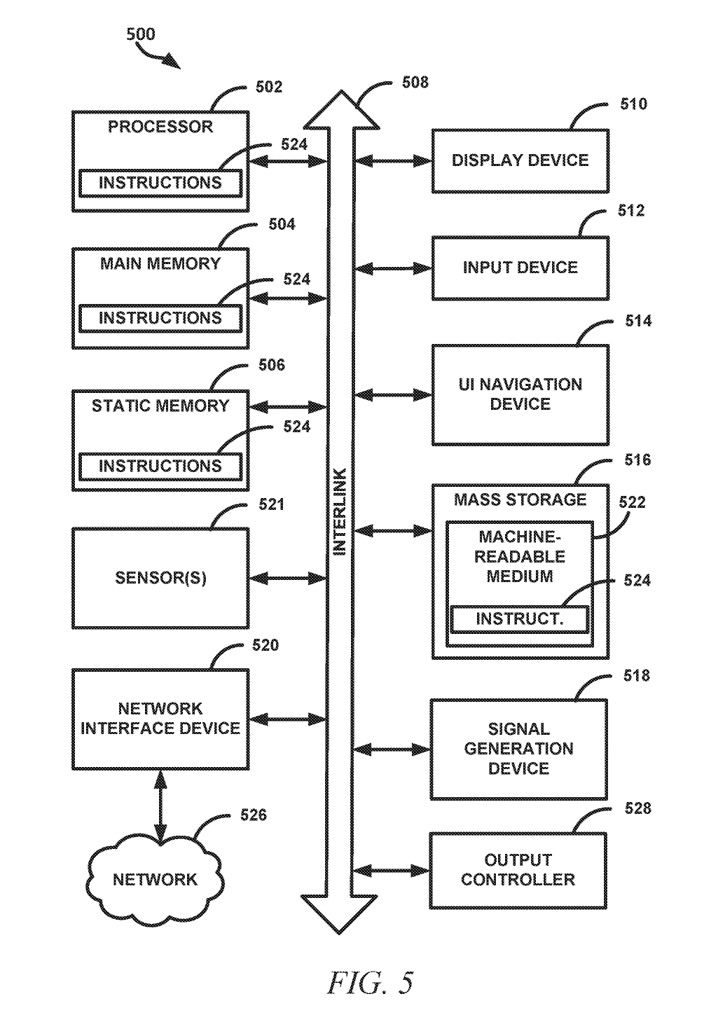

FIG. 5 illustrates, by way of example, a block diagram of an embodiment of a machine 500 (e.g., a computer system) to implement prediction or decision making process (e.g., one or more of training and prediction as discussed herein. One or more of the prediction system 100 and training system 150 may include one or more of the components of the machine 500. One example machine 500 (in the form of a computer), may include a processing unit 502, memory 503, removable storage 510, and non-removable storage 512. Although the example computing device is illustrated and described as machine 500, the computing device may be in different forms in different embodiments. For example, the computing device may instead be a smartphone, a tablet, smartwatch, or other computing device including the same or similar elements as illustrated and described regarding FIG. 1. Devices such as smartphones, tablets, and smartwatches are generally collectively referred to as mobile devices. Further, although the various data storage elements are illustrated as part of the machine 500, the storage may also or alternatively include cloud-based storage accessible via a network, such as the Internet. One or more of the components of the prediction system 100 and/or training system 150 may be implemented using, or include, one or more components of the machine 500.

Memory 503 may include volatile memory 514 and non-volatile memory 508. The machine 500 may include or have access to a computing environment that includes a variety of computer-readable media, such as volatile memory 514 and non-volatile memory 508, removable storage 510 and non-removable storage 512. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM). Digital Versatile Disks (DVD) or other optical disk storage, magnetic cassettes, magnetic tape, magnetic disk storage or other magnetic storage devices capable of storing computer-readable instructions for execution to perform functions described herein.

The machine 500 may include or have access to a computing environment that includes input 506, output 504, and a communication connection 516. Output 504 may include a display device, such as a touchscreen, that also may serve as an input device. The input 506 may include one or more of a touchscreen, touchpad, mouse, keyboard, camera, one or more device-specific buttons, one or more sensors integrated within or coupled via, wired or wireless data connections to the machine 500, and other input devices. The computer may operate in a networked environment using a communication connection to connect to one or more remote computers, such as database servers, including cloud based servers and storage. The remote computer may include a personal computer (PC), server, router, network PC, a peer device or another common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 502 of the machine 500, A hard drive. CD-ROM, and RAM are some examples of articles including a non-transitory computer-readable medium such as a storage device. For example, a computer program 1018 may be used to cause processing unit 502 to perform one or more methods or algorithms described herein.

### Additional Notes and Examples

Example 1 includes a system comprising a first device comprising a first processor and a first memory device, the first memory device including a program stored thereon for execution by the first processor to perform first operations, the first operations comprising projecting, using a sparse matrix, first and second sets of known vectors of a first dimensional space to first and second sets of lower dimensional vectors, respectively, the first and second sets of lower dimensional vectors of a second dimensional space lower than the first dimensional space, the first and second sets of known vectors associated with a prediction, determining one or more first prototype vectors to represent the first lower dimensional vectors, the first prototype vectors of the second dimensional space, determining one or more second prototype vectors to represent the second lower dimensional vectors, the second prototype vectors of the second dimensional space, and providing the first one or more prototype vectors, second one or more prototype vectors, and sparse matrix to a second device, the second device comprising a second processor and a random-access memory (RAM) device with a maximum of one megabyte of storage capacity coupled to the second processor, the RAM device including a program stored thereon for execution by the second processor to perform second operations, the second operations comprising projecting a prediction vector of a third dimensional space to the second dimensional space, the second dimensional space less than the third dimensional space, determining whether the projected prediction vector is closer to the one or more first prototype vectors or the one or more second prototype vectors, and determining a prediction by identifying (1) the prediction associated with the first set of known vectors in response to determining the projected prediction vector is closer to the one or more first prototype vectors and (2) the prediction associated with the second set of known vectors in response to determining the projected prediction vector is closer to the one or more second prototype vectors.

In Example 2, Example 1 may further include, wherein determining the one or more first prototype vectors includes randomly selecting one or more first lower dimensional vectors of the first set of lower dimensional vectors, and determining the one or more second prototype vectors includes randomly selecting one or more second lower dimensional vectors of the second set of lower dimensional vectors.

In Example 3, at least one of Examples 1-2 may further include, wherein determining the one or more first prototype vectors includes selecting a cluster center of the first lower dimensional vectors, and determining the one or more second prototype vectors includes selecting a cluster center of the second lower dimensional vectors.

In Example 4, Example 3 may further include, wherein the prediction is a binary or multi-class prediction.

In Example 5, at least one of Examples 1-4 may further include, wherein the first operations further comprise training the sparse matrix, the prototypes, and prototype labels simultaneously.

In Example 6, Example 5 may further include, wherein training the sparse matrix, the prototypes, and the prototype labels simultaneously, includes performing a stochastic gradient descent or projected gradient descent depending on a size of the first and second sets of known vectors.

In Example 7, Example 6 may further include, wherein training the sparse matrix further includes using an alternating reduction technique that includes fixing the prototypes and corresponding prototype score vectors to respective fixed values while adjusting the sparse matrix based on the fixed values.

In Example 8, Example 7 may further include, wherein training the sparse matrix further includes reducing an L2 loss function that is dependent on vales of the sparse matrix, the prototypes, and the corresponding prototype score vectors.

In Example 9, Example 8 may further include, wherein training the sparse matrix further includes constraining a number of non-zero entries of the sparse matrix to less than a specified first threshold, constraining a number of non-zero entries of the prototypes to less than a specified second threshold, and constraining a number of non-zero entries of the score vectors to less than a specified third threshold.

In Example 10, Example 9 may further include, wherein a sum of the first, second, and third thresholds is less than a storage capacity of the RAM and the prototypes, prototype labels, sparse matrix, and prototype score vectors are all stored on the RAM.

Example 11 may include a method of making a prediction, the method comprising constraining a number of non-zero entries of a sparse matrix to less than a specified first threshold, constraining a number of non-zero entries of prototype vectors to less than a specified second threshold, and constraining a number of non-zero entries of corresponding prototype score vectors to less than a specified third threshold, the sparse matrix and prototype vectors of a first dimensional space, the prototype vectors including first prototype vectors that represent a first prediction outcome and second prototype vectors that represent a second prediction outcome, training, based on the constraints and using a first device, the sparse matrix, the prototype vectors, prototype labels, and the corresponding prototype score vectors simultaneously, storing the sparse matrix, prototype vectors, and prototype labels on a random-access memory (RAM) of a second device, projecting, using the second device, a prediction vector of a second dimensional space to the first dimensional space, the first dimensional space less than the second dimensional space, determining whether the projected prediction vector is closer to the one or more first prototype vectors or the one or more second prototype vectors, and determining a prediction by identifying (1) the first prediction outcome associated with the first prototype vectors in response to determining the projected prediction vector is closer to the one or more first prototype vectors and (2) the second prediction outcome associated with the second prototype vectors in response to determining the projected prediction vector is closer to the one or more second prototype vectors.

In Example 12. Example 11 may further include projecting, using the sparse matrix, first and second sets of known vectors of a third dimensional space to first and second sets of lower dimensional vectors, the first and second sets of known vectors associated with the first and second predictions, respectively, determining the one or more first prototype vectors to represent the first lower dimensional vectors, and determining the one or more second prototype vectors to represent the second lower dimensional vectors.

In Example 13, Example 12 may further include determining the one or more first prototype vectors includes randomly selecting one or more first lower dimensional vectors of the first set of lower dimensional vectors, and determining the one or more second prototype vectors includes randomly selecting one or more second lower dimensional vectors of the second set of lower dimensional vectors.

In Example 14, Example 12 may further include, wherein determining the one or more first prototype vectors includes selecting a cluster center of the first lower dimensional vectors, determining the one or more second prototype vectors includes selecting a cluster center of the second lower dimensional vectors, and wherein the prediction is a binary or multi-class prediction.

In Example 15. Example 14 may further include, wherein training the sparse matrix, the prototypes, the prototype labels, and the score vectors simultaneously, includes performing a stochastic gradient descent or projected gradient descent depending on a size of the first and second sets of known vectors.

In Example 16, Example 15 may further include, wherein training the sparse matrix further includes using an alternating reduction technique that includes fixing the prototypes and prototype values to respective fixed values while adjusting the sparse matrix based on the fixed values.

In Example 17, Example 16 may further include, wherein training the sparse matrix further includes reducing an L2 loss function.

In Example 18, Example 17 may further include, wherein a sum of the first, second, and third thresholds is less than a storage capacity of the RAM and the prototypes, prototype labels, score vectors, and sparse matrix are all stored on the RAM.

Example 19 may include a non-transitory machine-readable medium including instructions for execution by a processor of a first device to perform operations comprising constraining a number of non-zero entries of a sparse matrix to less than a specified first threshold, constraining a number of non-zero entries of prototype vectors to less than a specified second threshold, and constraining a number of non-zero entries of corresponding prototype score vectors to less than a specified third threshold, the sparse matrix and prototype vectors of a first dimensional space, the prototype vectors including first prototype vectors that represent a first prediction outcome and second prototype vectors that represent a second prediction outcome, wherein a sum of the first, second, and third thresholds is less than a storage capacity of the RAM, training, based on the constraints, the sparse matrix, the prototype vectors, prototype labels, and the corresponding prototype score vectors simultaneously, and providing the sparse matrix, prototype vectors, and prototype labels on a random-access memory (RAM) of a second device, the RAM including a maximum of one megabyte storage.

In Example 20, Example 19 may further include, wherein projecting, using the sparse matrix, first and second sets of known vectors of a third dimensional space to first and second sets of lower dimensional vectors, the first and second sets of known vectors associated with the first and second predictions, respectively, determining the one or more first prototype vectors to represent the first lower dimensional vectors, and determining the one or more second prototype vectors to represent the second lower dimensional vectors.

In Example 21, Example 20 may further include, wherein determining the one or more first prototype vectors includes randomly selecting one or more first lower dimensional vectors of the first set of lower dimensional vectors, and determining the one or more second prototype vectors includes randomly selecting one or more second lower dimensional vectors of the second set of lower dimensional vectors.

In Example 22, Example 20 may further include, wherein determining the one or more first prototype vectors includes selecting a cluster center of the first lower dimensional vectors, determining the one or more second prototype vectors includes selecting a cluster center of the second lower dimensional vectors, and wherein the prediction is a binary or multi-class prediction.

In Example 23, at least one of Examples 19-22 may further include, wherein training the sparse matrix further includes using an alternating reduction technique that includes fixing the prototypes and prototype values to respective fixed values while adjusting the sparse matrix based on the fixed values.

In Example 24, at least one of Examples 19-23 may further include, wherein training the sparse matrix, the prototypes, the prototype labels, and the score vectors simultaneously, includes performing a stochastic gradient descent or projected gradient descent depending on a size of the first and second sets of known vectors.

In Example 25, at least one of Examples 19-24 may further include, wherein training the sparse matrix further includes reducing an L2 loss function.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A system comprising:
a first device comprising a first processor and a first memory device, the first memory device including a program stored thereon for execution by the first processor to perform first operations, the first operations comprising:
projecting, using a sparse matrix, first and second sets of known vectors of a first dimensional space to first and second sets of lower dimensional vectors, respectively, the first and second sets of lower dimensional vectors of a second dimensional space lower than the first dimensional space, the first and second sets of known vectors associated with a prediction;
determining one or more first prototype vectors to represent the first lower dimensional vectors, the first prototype vectors of the second dimensional space;
determining one or more second prototype vectors to represent the second lower dimensional vectors, the second prototype vectors of the second dimensional space; and
providing the first one or more prototype vectors, second one or more prototype vectors, and sparse matrix to a second device;
the second device comprising a second processor and a random-access memory (RAM) device with a maximum of one megabyte of storage capacity coupled to the second processor, the RAM device including a program stored thereon for execution by the second processor to perform second operations, the second operations comprising:
projecting a prediction vector of a third dimensional space to the second dimensional space, the second dimensional space less than the third dimensional space;
determining whether the projected prediction vector is closer to the one or more first prototype vectors or the one or more second prototype vectors; and
determining a prediction by identifying (1) the prediction associated with the first set of known vectors in response to determining the projected prediction vector is closer to the one or more first prototype vectors and (2) the prediction associated with the second set of known vectors in response to determining the projected prediction vector is closer to the one or more second prototype vectors.

2. The system of claim 1, wherein:
determining the one or more first prototype vectors includes randomly selecting one or more first lower dimensional vectors of the first set of lower dimensional vectors, and
determining the one or more second prototype vectors includes randomly selecting one or more second lower dimensional vectors of the second set of lower dimensional vectors.

3. The system of claim 1, wherein:
determining the one or more first prototype vectors includes selecting a cluster center of the first lower dimensional vectors; and
determining the one or more second prototype vectors includes selecting a cluster center of the second lower dimensional vectors.

4. The system of claim 3, wherein the prediction is a binary or multi-class prediction.

5. The system of claim 1, wherein the first operations further comprise:
training the sparse matrix, the prototypes, and prototype labels simultaneously.

6. The system of claim 5, wherein training the sparse matrix, the prototypes, and the prototype labels simultaneously, includes performing a stochastic gradient descent or projected gradient descent depending on a size of the first and second sets of known vectors.

7. The system of claim 6, wherein training the sparse matrix further includes using an alternating reduction technique that includes fixing the prototypes and corresponding prototype score vectors to respective fixed values while adjusting the sparse matrix based on the fixed values.

8. The system of claim 7, wherein training the sparse matrix further includes reducing an L2 loss function that is dependent on vales of the sparse matrix, the prototypes, and the corresponding prototype score vectors.

9. The system of claim 8, wherein training the sparse matrix further includes constraining a number of non-zero entries of the sparse matrix to less than a specified first threshold, constraining a number of non-zero entries of the prototypes to less than a specified second threshold, and constraining a number of non-zero entries of the score vectors to less than a specified third threshold.

10. The system of claim 9, wherein a sum of the first, second, and third thresholds is less than a storage capacity of the RAM and the prototypes, prototype labels, sparse matrix, and prototype score vectors are all stored on the RAM.

11. A method of making a prediction, the method comprising:
constraining a number of non-zero entries of a sparse matrix to less than a specified first threshold, constraining a number of non-zero entries of prototype vectors to less than a specified second threshold, and constraining a number of non-zero entries of corresponding prototype score vectors to less than a specified third threshold, the sparse matrix and prototype vectors of a first dimensional space, the prototype vectors including first prototype vectors that represent a first prediction outcome and second prototype vectors that represent a second prediction outcome;
training, based on the constraints and using a first device, the sparse matrix, the prototype vectors, prototype labels, and the corresponding prototype score vectors simultaneously;
storing the sparse matrix, prototype vectors, and prototype labels on a random-access memory (RAM) of a second device;
projecting, using the second device, a prediction vector of a second dimensional space to the first dimensional space, the first dimensional space less than the second dimensional space;
determining whether the projected prediction vector is closer to the one or more first prototype vectors or the one or more second prototype vectors; and
determining a prediction by identifying (1) the first prediction outcome associated with the first prototype vectors in response to determining the projected prediction vector is closer to the one or more first prototype vectors and (2) the second prediction outcome associated with the second prototype vectors in response to determining the projected prediction vector is closer to the one or more second prototype vectors.

12. The method of claim 11, wherein:
projecting, using the sparse matrix, first and second sets of known vectors of a third dimensional space to first and second sets of lower dimensional vectors, the first and second sets of known vectors associated with the first and second predictions, respectively;
determining the one or more first prototype vectors to represent the first lower dimensional vectors; and
determining the one or more second prototype vectors to represent the second lower dimensional vectors.

13. The method of claim 12, further comprising:
determining the one or more first prototype vectors includes randomly selecting one or more first lower dimensional vectors of the first set of lower dimensional vectors, and
determining the one or more second prototype vectors includes randomly selecting one or more second lower dimensional vectors of the second set of lower dimensional vectors.

14. The method of claim 12, wherein:
determining the one or more first prototype vectors includes selecting a cluster center of the first lower dimensional vectors;
determining the one or more second prototype vectors includes selecting a cluster center of the second lower dimensional vectors; and
wherein the prediction is a binary or multi-class prediction.

15. The method of claim 14, wherein training the sparse matrix, the prototypes, the prototype labels, and the score vectors simultaneously, includes performing a stochastic gradient descent or projected gradient descent depending on a size of the first and second sets of known vectors.

16. A non-transitory machine-readable medium including instructions for execution by a processor of a first device to perform operations comprising:
constraining a number of non-zero entries of a sparse matrix to less than a specified first threshold, constraining a number of non-zero entries of prototype vectors to less than a specified second threshold, and constraining a number of non-zero entries of corresponding prototype score vectors to less than a specified third threshold, the sparse matrix and prototype vectors of a first dimensional space, the prototype vectors including first prototype vectors that represent a first prediction outcome and second prototype vectors that represent a second prediction outcome, wherein a sum of the first, second, and third thresholds is less than a storage capacity of the RAM;
training, based on the constraints, the sparse matrix, the prototype vectors, prototype labels, and the corresponding prototype score vectors simultaneously; and
providing the sparse matrix, prototype vectors, and prototype labels on a random-access memory (RAM) of a second device, the RAM including a maximum of one megabyte storage.

17. The non-transitory machine-readable medium of claim 16, wherein:
projecting, using the sparse matrix, first and second sets of known vectors of a third dimensional space to first and second sets of lower dimensional vectors, the first and second sets of known vectors associated with the first and second predictions, respectively;
determining the one or more first prototype vectors to represent the first lower dimensional vectors; and
determining the one or more second prototype vectors to represent the second lower dimensional vectors.

18. The non-transitory machine-readable medium of claim 17, wherein:
determining the one or more first prototype vectors includes randomly selecting one or more first lower dimensional vectors of the first set of lower dimensional vectors, and
determining the one or more second prototype vectors includes randomly selecting one or more second lower dimensional vectors of the second set of lower dimensional vectors.

19. The non-transitory machine-readable medium of claim 17, wherein:
determining the one or more first prototype vectors includes selecting a cluster center of the first lower dimensional vectors;
determining the one or more second prototype vectors includes selecting a cluster center of the second lower dimensional vectors; and
wherein the prediction is a binary or multi-class prediction.

20. The non-transitory machine-readable medium of claim 16, wherein training the sparse matrix further includes using an alternating reduction technique that includes fixing the prototypes and prototype values to respective fixed values while adjusting the sparse matrix based on the fixed values.
